(19) United States
(12) Patent Application Publication
(10) Pub. No.: US 2008/0112480 A1
(43) Pub. Date: May 15, 2008

(54) Method for Analog Transmission of a Video Signal

(75) Inventor: Thomas Frommann, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/019,006

(22) Filed: Jan. 24, 2008

Related U.S. Application Data
(63) Continuation of application No. PCT/EP2005/008128, filed on Jul. 27, 2005.

(51) Int. Cl. H04B 1/66

(52) U.S. Cl. 375/240

(57) ABSTRACT

A method for analog transmission of a video signal from a video source to a video sink is provided. The video signal contains a sequence of frames with a first image resolution and a first image frequency at the video source. The sequence of frames is converted to a sequence of image segments having a second image resolution that is lower than the first image resolution, and an image frequency that is higher than the first image frequency. The sequence of image segments is transmitted from the video source to the video sink, and a sequence of frames having the first image resolution is reconstructed at the video sink, the first image resolution is higher than the image resolution of a frame according to a video standard, and the second image resolution is equal to the image resolution of a frame or field according to the said video standard.

### CROSS REFERENCE TO RELATED APPLICATIONS

This application is a continuation of PCT International Application No. PCT/EP2005/008128, filed Jul. 27, 2005, the entire disclosure of which is herein expressly incorporated by reference.

### BACKGROUND AND SUMMARY OF THE INVENTION

The present invention relates to a method for analog transmission of a video signal from a video source to a video sink. The video signal contains a sequence of frames which are present with a first image resolution and a first image frequency at the video source. The sequence of frames for physical transmission is converted to a sequence of image segments having a second image resolution that is lower than the first image resolution, and having an image frequency that is higher than the first image frequency. The sequence of image segments is transmitted from the video source to the video sink, and a sequence of frames having the first image resolution is reconstructed from the transmitted sequence of image segments at the video sink.

The present invention further relates to a video source, preprocessor, video sink and post processor for use in such a method.

Video signals may be transmitted in an analog or a digital manner. Although in some respects analog image transmission is more susceptible to interference than digital image transmission, analog image transmission is generally more economical to implement. In addition, the susceptibility to interference is less critical when a wired transmission is employed over short distances. This corresponds, for example, to the objective of many applications in current motor vehicles, for which reason analog methods are predominantly used for image transmission in the automotive field.

The most favorable widespread analog transmission method for video signals in current use is the FBAS method (CVBS composite video), originally developed for television technology, which makes use of a brightness signal (luminance or Y) and a modulated color subcarrier signal (chrominance or C) in order to transmit the image information. In normal wireless transmission, both signals are combined into one signal (composite video) on the transmitter side and are separated on the receiver side. Since the separation of the signals is not a trivial matter from a technical standpoint and is associated with losses in quality, the signals in wired broadcasting technology and in the commercial consumer area are often transmitted separately (Y/C) via separate lines. In the European region, the transmission of three individual component signals (RGB) is frequently used, for example between broadcasting stations and television sets via the SCART interface. Standards have been defined (for example, PAL or NTSC) for this transmission method which allow the combined transmission of both signals in a limited frequency band (typically 6.75 MHz). This standardization has resulted in widespread use and availability of advantageous components, in the automotive sector as well. Thus, this method is currently used in motor vehicles for signal transmission between TV receivers, DVD changers, various camera sources, and the associated display units.

The upper limit of the frequency band (6.75 MHz, for example) defines an upper barrier for the achievable local resolution of the transmitted video signal. Thus, the NTSC standard, for example, defines the transmission of 30 individual frames per second, each with 525 lines and 857 sample values per line (6.75 MHz×2 sample values/oscillation=13.5 MHz=30 frames*525 lines*857 samples). The individual frames are transmitted as fields having half the number of lines. Some of the lines and sample values per line are used not for actual image data, but rather for the transmission of synchronization signals (HSYNC, VSYNC), which for NTSC results, for example, in an active image resolution of 720×480 pixels per frame or 720×240 pixels per field.

The image resolution of such a standardized transmission method is adequate for the majority of applications currently in common use in motor vehicles and display units with moving image content (for example, entertainment, rear-view backup camera). However, new applications and the availability of relatively economical high-resolution display units have resulted in the requirement for displaying video signals with higher image resolution (for example, 800×480 or 1280×480 pixels). Unchanged display of a video signal transmitted according to one of the widespread standards (NTSC, for example) on a high-resolution display unit, however, results in undersampling and, therefore, a noticeable loss of quality, primarily in the representation of individual pixels. The manifestation of this disadvantage is particularly serious for the display of detailed image content such as navigation maps, Web browsers, text displays, characteristic curves, and symbol overlays in camera images.

For remedying these problems, other transmission methods are currently used in individual applications which, for example, increase the transmission frequency or even provide for digital transmission of the image data. Although these methods provide satisfactory results, they involve a high level of technical complexity and correspondingly higher costs. This is particularly true when, as the result of use of different transmission methods, the video sinks in a system must have various inputs for video sources that use different transmission methods.

Exemplary embodiments of the present invention provide a simple method for transmission of video signals in sufficient image quality for high-resolution video sinks.

Exemplary embodiments of the invention provide a preprocessor, video source, post processor and video sink for use in such a method.

The first-referenced object according to the invention is achieved by an exemplary method of the present invention involves a first image resolution that is higher than the image resolution of a frame according to a video standard, and a second image resolution that is equal to the image resolution of a frame or field according to said video standard.

Conventional methods for analog reception, transmission, and display of images employ interlacing in which a frame is divided into two interlaced fields which are successively transmitted. Unlike the present invention, however, in such a method the source format, transmission format, and display format are typically the same—in each case only fields are involved in the reception, transmission, and display. For such methods, in certain cases a frame is then also reconstructed from the transmitted fields. However, the conversion of two fields to a frame, such as for a car communication computer (CCC) according to the prior art or for progressive scan displays, represents only a necessary adjustment of the source format (fields) to the display format (frames)—here as well, the source format and transmission format are the same. In contrast, the method according to the invention makes use of “field transmission” in order to effectively transmit a different, qualitatively higher, in particular higher-resolution, source format and to use same in the video sink, for example for the display.

The method used according to the invention differs from known methods, at least with respect to the use of a first image resolution that is higher than the image resolution of a frame according to a video standard, and a second image resolution that is equal to the image resolution of a frame or field according to said video standard. However, on account of the boundary conditions and objectives described in the preceding paragraph and also in the paragraph following below, the actual difference of the invention from the methods known from the prior art far exceeds the mere additive effect of the characterizing features.

Insofar as certain features cited in the claims are known from the prior art, in the prior art they are used for a completely different purpose than in the invention. Whereas in a method according to the prior art the objective is to increase the display frequency at the video sink by dividing the frames, in the invention this aspect is regarded more in a peripheral manner. Quite the opposite, depending on the embodiment, the invention in many cases even adversely affects the display frequency. Instead of the display frequency, the invention increases the image resolution of the effectively transmitted video signal.

One advantage of the invention is that, by using means for existing economical image transmission methods already available from the prior art, a higher image resolution—in this context the local resolution, which is usually expressed in pixels—is achieved for the video signal which is effectively transmitted to the video sink. The high image transmission quality requirements of many applications are thus met without additional costs, or at extremely low cost. In this manner better use may be made of a high-resolution display unit, for example. Image-processing video sinks, such as for a camera-based driver assistance system, may likewise be provided with high-quality input video signals by use of the invention.

According to exemplary embodiments of the present invention, the first image resolution is higher than the image resolution of a frame according to the NTSC or PAL standard, and the second image resolution is equal to the image resolution of a field according to the corresponding video standard, i.e., according to NTSC or PAL. Primarily fields are transmitted according to the NTSC or PAL standard. Devices and methods that are suitable for the transmission of fields for these widely used video standards are therefore in particular economically available. According to the prior art, the transmitted NTSC or PAL fields are generally interlaced in pairs. However, this is not absolutely necessary for use of the available transmission technology. The methods and devices available for the physical transmission may be used in the same way for the transmission of any given image segments, provided that the image segments have the data format of an NTSC or PAL field. Accordingly, the high-resolution frames according to the embodiments of the invention addressed here which are present at the video source are divided into image segments having the data format of such a field.

The same applies for the transmission of image segments in the data format of frames according to the NTSC or PAL standard, or fields or frames according to other video standards such as SECAM. For example, it is advantageous to select the image resolution of the transmitted image segments to be equal to the image resolution of a frame according to the PAL standard, provided that suitable means are available for transmitting PAL frames.

The image resolution of the image segments preferably agrees not just with the image resolution of the video standard used for the transmission. It is preferred that in addition, the second image frequency, i.e., the image frequency of the transmitted image segments, is equal to the typical image frequency for transmitting frames or fields according to said video standard, in particular NTSC or PAL. Devices and methods which are suitable for the image transmission according to such a video standard may be used for the invention in a particularly simple manner. Provided that the second image resolution, i.e., the image resolution of the image segments, is equal to the image resolution of a field according to said video standard, the typical image frequency for transmitting fields according to said video standard is particularly advantageous as the second image frequency. Provided that the second image resolution is equal to the image resolution of a frame according to said video standard, the typical image frequency for transmitting frames according to said video standard is particularly advantageous as the second image frequency.

The previously described features and embodiments of the invention are used to pack the video signal, which is to be actually transmitted, in image segments of a given data format for the purpose of physical transmission. Accordingly, for the physical transmission, transmission means are also used which are designed for the transmission of such a data format. The sequence of image segments can be transmitted over a standardized transmission path which is designed for the transmission of frames or fields having the second image resolution and the second image frequency.

The sequence of frames which is reconstructed at the video sink may be the same as the sequence of frames that is initially present at the video source; in particular, both sequences may have the same image frequency. The latter embodiment is particularly practical when a new frame is always reconstructed and used by the video sink—for example, displayed by a display unit—only after the transmission of all image segments from which a new complete frame may be reconstructed.

Alternatively, the sequence of frames which is reconstructed at the video sink may have a higher image frequency than the sequence of frames that is initially present at the video source. In particular, the image frequency of the reconstructed sequence may be the same as the image frequency of the physically transmitted sequence of image segments. The latter embodiment is particularly practical when a new frame is reconstructed and used by the video sink after the transmission of each individual image segment.

The reconstructed frame sequence may be processed by a video sink, typically a display unit, either in its own image frequency or in a preferred image frequency of the video sink. The reconstructed frame sequence can be reconstructed in a preferred image frequency of the video sink and displayed. In this manner optimal use is made of the video sink and unnecessary effort for reconstruction is avoided.

If the preferred image frequency of the video sink exceeds the image frequency of the reconstructed frame sequence, individual frames or all reconstructed frames may be repeatedly displayed in order to maintain the preferred image frequency of the video sink.

The method according to the invention provides for decoupling between the data format (in particular the image resolution and the image frequency, if applicable) of the image units present at the video source, in this case frames, and the data format of the image units that are to be physically transmitted over the transmission path, in this case the image segments. Adjustment to an available transmission path with limited bandwidth is achieved by selecting the image resolution of the image units that are to be physically transmitted to be smaller than the frames that are initially present. In this manner it is possible to effectively transmit sequences of frames of practically any given level of image resolution. However, an important boundary condition is that the image frequency of the effectively transmitted frame sequence necessarily decreases with increasing image resolution of the frame sequence.

Although increasing the image resolution according to the invention adversely affects the image frequency of the effectively transmitted frame sequence, in many applications, in particular for the display of stationary or slowing moving image content, this is tolerable with little or no sacrifice of quality. The invention takes into account the fact that in many current applications for image display in motor vehicles (for example, display of navigation maps, Web browsers, text displays, characteristic curves, and symbol overlays in camera images) it is precisely such stationary or slowing moving image content that is to be displayed. Current applications of image display in motor vehicles differ significantly from the typical applications for image display outside of motor vehicles. Accordingly, the invention is preferably used for the transmission of a video signal in a motor vehicle.

The disadvantage of the decreased image frequency is further reduced in the automotive sector as a result of the typical use profile of the user of display units in motor vehicles. Display units in motor vehicles, in contrast to display units outside of motor vehicles, are usually observed only momentarily by the user. For example, the glimpse at a navigation map by means of which a driver checks his position on a route usually lasts only a few seconds. For such a short observation time, a slightly jerky image stream due to the reduced image frequency is rarely subjectively perceived as objectionable by the observer, for which reason according to the invention more emphasis may be placed on the much more important image resolution for the shorter observation time. Furthermore, for many applications in the motor vehicle, new data are available only at an update rate which is already much lower than the image frequency of the display unit, or the image frequency of the frame sequence that is effectively transmittable according to the invention.

In principle, the pixels of the high-resolution frame present at the video source may be distributed in any given manner over the individual transmitted image segments. It is necessary only to reconstruct the high-resolution frame from the image segments.

Each image segment can contain portions of only a single frame present at the video source. Alternatively, variants of the invention can involve individual image segments that contain portions of multiple frames present at the video source.

Each image segment can contain at least one contiguous portion of a high-resolution frame that is present at the video source. According to one exemplary embodiment of the present invention, each image segment is composed of a single contiguous portion of a high-resolution frame that is present at the video source.

The transmitted image segments may contain disjunct image information. In effect, a particularly large amount of image information, i.e., particularly large frames, may thus be transmitted from the video source to the video sink. Alternatively, the image segments may contain redundant information. For example, the portions of the high-resolution frame contained in various image segments may mutually overlap in the frame.

To allow the image resolution of the frames effectively transmitted by use of the method according to the invention to actually be increased, for transmission of image segments having the image resolution of fields of a video standard in each case a frame that is present at the video source is divided into at least three image segments. For transmission of image segments having the image resolution of frames of a video standard, increasing the image resolution of the frames effectively transmitted by use of the method according to the invention is already possible by dividing each frame that is present at the video source into at least two image segments.

According to one exemplary embodiment of the present invention, a sequence of high-resolution frames of image resolution 1440×480 is present at the video source, and each frame present at the video source is divided into four image segments having the image resolution of fields of the NTSC video standard, and the image segments having the image resolution of fields of the NTSC video standard are physically transmitted. In this case, a particularly technically simple division of the high-resolution frame into the four image segments is possible by quartering of the frames present at the video source.

The image resolution of the frames that can be effectively transmitted by use of the method according to the invention can be at least as high as the image resolution required at the video sink. For example, a frame of image resolution 1440×480 may be directly displayed on a display unit having 1440×480 pixels if such a display unit is available. In practice, a display unit is often available which has a pixel count that is between the image resolution of the frames that can be effectively transmitted by use of the method according to the invention and the image resolution of a video standard. In current motor vehicles, a display on a display unit having 1280×480 pixels, for example, is frequently employed. In such a case, a frame sequence having a higher image resolution may be transmitted by use of the method according to the invention. The reconstructed frames may then either be cropped or scaled to the image resolution of the display unit. Alternatively, an adjustment to the preferred image resolution of the video sink may be made during the reconstruction.

The method according to the invention may be implemented by additional programming on many graphics processors which are known from the prior art and economically available. Alternatively, the invention may also be implemented by a comparatively simple connection in future graphics processors.

According to the above discussion, the second-referenced object of the invention is achieved by use of a video source which is suitable for converting an incoming sequence of frames, having an image resolution that is higher than the image resolution of a frame according to a video standard, to an outgoing sequence of image segments having an image resolution that is equal to the image resolution of a frame or field of said video standard.

For this purpose the video source may contain a preprocessor, which may also be embodied separately. Exemplary embodiments of the invention provide a preprocessor which is suitable for converting an incoming sequence of frames, having an image resolution that is higher than the image resolution of a frame according to a video standard, to an outgoing sequence of image segments having an image resolution that is equal to the image resolution of a frame or field of said video standard.

Such a video source or such a preprocessor may be produced by slightly modifying a graphics processor according to the prior art. Typically, a video source provides an image n for transmission until a new image n+1 is completely generated. In the interlacing method, for example, all even-numbered lines, then all the odd-numbered lines, of the image n are alternatingly transmitted as fields.

The transmission of these fields from an image memory usually only requires the setting of a start address and line length of the first pixel of the first line of a field. The remaining pixels and lines of a field are automatically outputted by use of an appropriate address incrementer. This process may be easily modified so that the start address and line length are sequentially set to the first pixel of the first line of the individual image segments of a high-resolution frame. The remaining pixels and lines of an image segment are then transmitted in a manner analogous to the transmission of individual fields.

Exemplary embodiments of the invention provide a video sink which is suitable for reconstructing, from an incoming sequence of image segments having an image resolution that is equal to the image resolution of a frame or field of a video standard, a sequence of frames having an image resolution that is higher than the image resolution of a frame of said video standard.

For this purpose the video sink may contain a postprocessor, which may also be embodied separately. Exemplary embodiments of the invention provide a postprocessor which is suitable for reconstructing, from an incoming sequence of image segments having an image resolution that is equal to the image resolution of a frame or field of a video standard, a sequence of frames having an image resolution that is higher than the image resolution of a frame of said video standard.

Such a video sink or such a postprocessor may be produced by slightly modifying a graphics processor according to the prior art. Customary graphics processors offer the possibility of storing incoming pixels of a field in an image memory. The contents of this image memory may then be further processed and/or displayed. Graphics processors already assist in the display of frames (progressive displays) and in the reconstruction of a frame from two fields (de-interlacing according to the BOB or WEAVE methods). These methods join two fields, either during storage of the incoming pixels, or by the display of alternating even and odd lines during outputting of the frame. These processes may be altered by simple modification during the addressing of the image memory areas in such a way that either during storage of the incoming pixels of the individual image segments a reconstruction of a high-resolution image occurs in the image memory, or the outputting process is modified so that in each case the appropriate image segments are read from the image memory and displayed. These modifications may be performed as add-ons to hardware or firmware of a graphics processor. Graphics processors also offer the possibility of combining various image memory contents during outputting in the form of layers which may overlap, such as the overlapping of an on-screen display via a running video image. A layer generally defines a contiguous image memory area (start address and line length), which in the form of a rectangular region (start position and line length) may be freely positioned in the display region and displayed. These layer parameters are statically or dynamically adjusted by means of a freely programmable processor which may be designed as part of a graphics processor or as an additional processor. A reconstructed frame may then be displayed by means of a program which at the start of a display cycle (VSYNC) programs the layer parameters in such a way that each layer displays an associated image segment at the appropriate location. As soon as all image segments of image n+1 are received, the layer parameters of the image segments of image n may be converted to image segments n+1. New image segments of image n+2 are stored in parallel in the image memory. The memory used for the image segments of image n may be cleared for subsequent receipt of the image segments of image n+3, etc. (ring buffer method).

The method according to the invention maintains an existing video standard for the actual physical transmission of the image information. The method thus allows an economical overall system in which video signals according to existing video standards and high-resolution image content may be mutually transmitted.

The method according to the invention is based on existing cost-optimized methods for video transmission, thereby avoiding additional costs for more complex transmission methods. The method according to the invention allows increased image quality and readability of high-resolution image content compared to methods of the prior art.

Other objects, advantages and novel features of the present invention will become apparent from the following detailed description of the invention when considered in conjunction with the accompanying drawings.

### BRIEF DESCRIPTION OF THE DRAWINGS

The invention is further explained with reference to the accompanying figures, which schematically show the following:

FIG. 1 shows the operation of a method according to the invention;

FIG. 2 shows the splitting according to the invention into four image segments of a frame to be transmitted; and

FIG. 3 shows an excerpt of the time progression of the occupancy of a transmission path that is used.

### DETAILED DESCRIPTION OF THE DRAWINGS

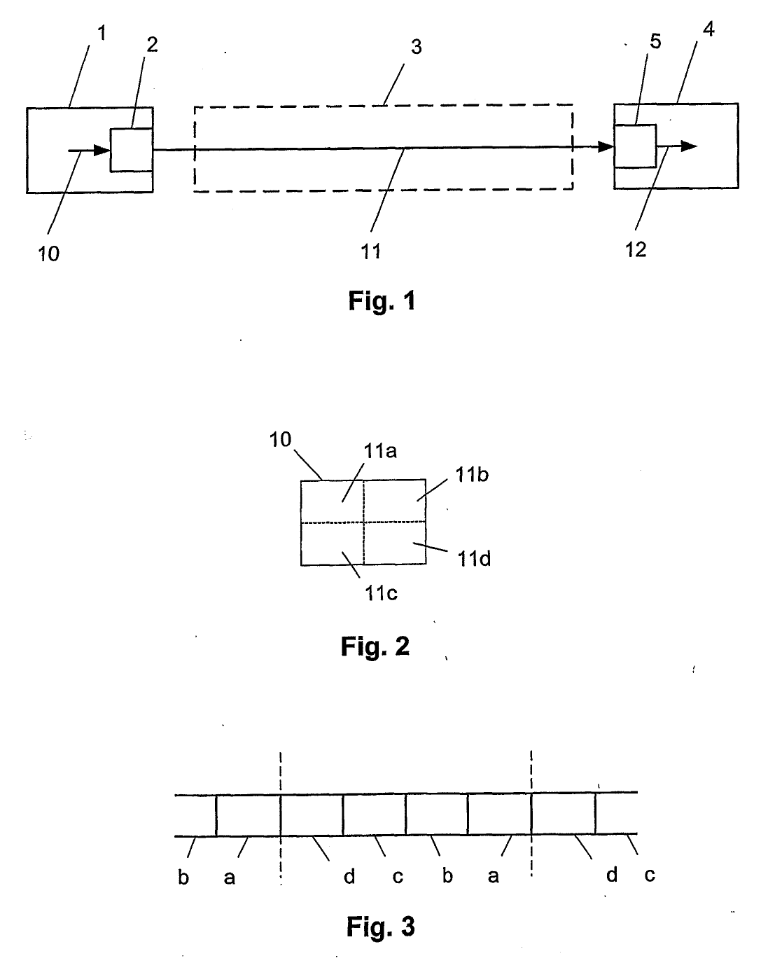

FIG. 1 illustrates the operating principle of a method according to the invention. The method according to the invention, described in greater detail below with reference to one embodiment of the invention, involves the conversion of a high-resolution sequence of frames 10 to a sequence of image segments 11 and the reconstruction of a sequence of frames 12 to be displayed.

A sequence of high-resolution frames 10 (image resolution 1440×480) is present at a video source 1. The preprocessor 2 which is integrated into the video source 1 splits each of these frames 10 into individual image segments 11 before the physical transmission. The image segments 11 have the image resolution of an NTSC field (720×240 pixels). Each frame 10 is split into four image segments 11.

The splitting of each frame into four image segments is illustrated in FIG. 2. FIG. 2 provides an overall schematic view of a frame 10 of 1440×480 image resolution. This is bordered by a solid line in FIG. 2. The dashed lines in FIG. 2 denote the division of the frame into image segments 11a, 11b, 11c, and 11d. Each image segment contains a contiguous portion of the frame 10.

The sequence of image segments 11 resulting from the splitting of the sequence of frames 10 has an image frequency four times that of the sequence of the frames 10. In the present example the sequence of frames 10 has an image frequency of 15 Hz. The sequence of image segments 11 correspondingly has an image frequency of 60 Hz.

Thus, the image resolution of the image segments 11 corresponds not just to the image resolution of an NTSC field. The image frequency of the sequence of image segments 11 also corresponds to the image frequency at which NTSC fields are transmitted according to the NTSC video standard. The sequence of image segments 11 may thus be easily transmitted over a standardized transmission path which is designed for the transmission of NTSC fields according to the NTSC video standard. The available transmission path 3 meets these requirements.

The sequence of image segments 11 is physically transmitted over the transmission path 3 to the video sink 4 by use of the existing NTSC method. Each of the four image segments of a frame is transmitted in the sequence a, b, c, d, for example. FIG. 3 shows an excerpt of the time progression of the occupancy of the transmission path 3. The information of a complete frame 10, packed in four image segments 11, is transmitted between the two dashed lines.

The video sink 4 contains a postprocessor 5 which receives the sequence of image segments 11 and recombines them into a sequence of frames 12 of image resolution 1440×480. One frame 12 is reconstructed from four image segments in which in each case a frame has been split by the preprocessor 2. The reconstructed frames 12 are essentially identical to the frames 10 previously present at the video source.

A slightly modified graphics processor according to the prior art may assume the function of the postprocessor. Such graphics processors are generally economically available. The frames 12 may be combined, for example, by mutually coordinated storage in corresponding regions of the graphics memory of the graphics processor. Otherwise, the physical reception process of the postprocessor may be carried out exactly as in the prior art.

Likewise, a slightly modified graphics processor according to the prior art may assume the function of the preprocessor 2 in the video source 1. In particular, the physical transmission process of the preprocessor may be carried out exactly as in the prior art. Economical hardware is generally available for this purpose as well.

The video sink 4 displays the reconstructed sequence of frames 12 at the image refresh rate of the display unit (in this case, 60 Hz); i.e., each frame 12 is displayed four times.

By use of the method according to the invention, the effective image frequency of the transmitted video signal is reduced to the field rate of the transmission method (in this case, NTSC at 60 Hz) divided by the number (in this case, four) of image segments per high-resolution frame. In the present case, this results in an effective image frequency of 15 Hz.

In the present exemplary embodiment the video sink 4 is designed as a display unit having a resolution of 1280×480 pixels and a preferred display frequency of 60 Hz. The displayed image stream is thus cropped on both sides when the pixels of the effectively transmitted video signal are directly converted to the pixels of the display unit.

In the exemplary embodiment described, the full resolution of a 1280×480×60 Hz display unit may be controlled by a conventional 720×240×60 Hz-Y/C video signal by splitting a 1440×480 frame for physical transmission into four 720×240 image segments. Although the effective image frequency is thus reduced to 15 frames per second, in many applications, in particular in the motor vehicle, this results in little or no disadvantage. This is outweighed by the advantages of the transmission of high-resolution frames by a conventional 720×240×60 Hz-Y/C video signal, and thus, using conventional hardware components.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for analog transmission of a video signal from a video source to a video sink,
in which the video signal contains a sequence of frames which are present with a first image resolution and a first image frequency at the video source, the method comprising:
converting the sequence of frames for physical transmission to a sequence of image segments having a second image resolution that is lower than the first image resolution, and having an image frequency that is higher than the first image frequency;
transmitting the sequence of image segments from the video source to the video sink; and
reconstructing a sequence of frames having the first image resolution from the transmitted sequence of image segments at the video sink,
wherein the first image resolution is higher than the image resolution of a frame according to a video standard, and
wherein the second image resolution is equal to the image resolution of a frame or field according to said video standard.

2. The method according to claim 1, wherein the video signal is transmitted in a motor vehicle.

3. The method according to claim 1, wherein the first image resolution is higher than the image resolution of a frame according to the NTSC or PAL standard, and
the second image resolution is equal to the image resolution of a field according to the NTSC or PAL standard.

4. The method according to claim 1, wherein the second image frequency is equal to the typical image frequency for transmitting frames or fields according to said video standard.

5. The method according to claim 1, wherein the sequence of image segments is transmitted over a standardized transmission path which is designed for the transmission of frames or fields having the second image resolution and the second image frequency.

6. The method according to claim 1, wherein the sequence of frames which is reconstructed at the video sink has the same image frequency as the sequence of frames that is initially present at the video source.

7. The method according to claim 1, wherein the sequence of frames which is reconstructed at the video sink is the same as the sequence of frames that is initially present at the video source.

8. The method according to claim 1, wherein the sequence of frames which is reconstructed at the video sink has a higher image frequency than that of the sequence of frames that is initially present at the video source.

9. The method according to claim 1, wherein a new frame is reconstructed at the video sink after the transmission of each image segment, and the image frequency of the reconstructed sequence is thus equal to the image frequency of the transmitted sequence of image segments.

10. The method according to claim 1, wherein each image that is present at the video source is divided into at least three image segments.

11. The method according to claim 1, wherein each image segment contains at least one contiguous portion of a frame that is present at the video source.

12. The method according to claim 1, wherein each frame present at the video source is divided into exactly four image segments, each having the image resolution of a field according to the NTSC video standard.

13. A video source that is arranged to convert an incoming sequence of frames, having an image resolution that is higher than the image resolution of a frame according to a video standard, to an outgoing sequence of image segments having an image resolution that is equal to the image resolution of a frame or field of said video standard.

14. A preprocessor that is arranged to convert an incoming sequence of frames, having an image resolution that is higher than the image resolution of a frame according to a video standard, to an outgoing sequence of image segments having an image resolution that is equal to the image resolution of a frame or field of said video standard.

15. A video sink arranged to reconstruct from an incoming sequence of image segments having an image resolution that is equal to the image resolution of a frame or field of a video standard, a sequence of frames having an image resolution that is higher than the image resolution of a frame of said video standard.

16. A postprocessor arranged to reconstruct from an incoming sequence of image segments having an image resolution that is equal to the image resolution of a frame or field of a video standard, a sequence of frames having an image resolution that is higher than the image resolution of a frame of said video standard.
